(19) United States
(12) Patent Application Publication
(10) Pub. No.: US 2011/0006892 A1
(43) Pub. Date: Jan. 13, 2011

(54) BENDABLE ON-DEMAND DISPLAY

(76) Inventor: DMITRY KARPINSKY, SCOTTSDALE, AZ (US)

Correspondence Address: Dmitry Karpinsky, P.O. Box 28963, Scottsdale, AZ, 85255, US

(21) Appl. No.: 12/499,128

(22) Filed: Jul. 8, 2009

(51) Int. Cl. G09F 9/00

(52) U.S. Cl. 340/461

(57) ABSTRACT

This invention relates to an electronic instrument panel for vehicles consisting of information display that is bendable and wraps around the interior contour of the vehicle. The display provides on-demand imaging where instruments are not in static, fixed position, but rather change based on conditions and environment the vehicle is in, and based on user or factory preferences and settings. The display can be continuous or fragmented around the vehicle with any contour angles. Information display can change colors, be self dimming and offer wide array of telemetry, entertainment, vehicle data, climate control, instrumentation, and powertrain information. The instrument panel will be online through wireless connectivity and provide the occupants real-time on-demand information about the vehicle and its surroundings through electronic display and human voice.

### CROSS REFERENCE TO RELATED APPLICATIONS

| Patent # | Title | Date Issued |
|---|---|---|
| D571271 | Meter panel for an automobile | Jun. 17, 2008 |
| D562748 | Instrument panel for an automobile | Feb. 26, 2008 |
| D557646 | Vehicle dashboard panel | Dec. 18, 2007 |
| D546744 | Meter for motorcycles | Jul. 17, 2007 |
| D543139 | Instrument cluster for a vehicle | May 22, 2007 |
| D531557 | Instrument cluster | Nov. 7, 2006 |
| D529847 | Instrument gauge cluster | Oct. 10, 2006 |
| D529423 | Vehicle instrument cluster | Oct. 3, 2006 |
| D512357 | Instrument panel | Dec. 6, 2005 |
| D512006 | Instrument panel | Nov. 29, 2005 |
| D499998 | Instrumental panel for automobiles | Dec. 21, 2004 |
| D494908 | Surface configuration of a dashboard for a vehicle | Aug. 24, 2004 |
| D493757 | Surface configuration of a dashboard for a vehicle | Aug. 3, 2004 |
| D493756 | Instrument panel for an automobile | Aug. 3, 2004 |
| D492632 | Surface configuration of a dashboard for a vehicle | Jul. 6, 2004 |
| D491504 | Instrument for displaying information, for use in an automobile | Jun. 15, 2004 |
| D489660 | Instrument panel | May 11, 2004 |
| D483309 | Instrument gauge | Dec. 9, 2003 |
| D469391 | Surface configuration of a dashboard for a vehicle | Jan. 28, 2003 |
| D467845 | Surface configuration of an instrument display for a vehicle | Dec. 31, 2002 |
| 6,404,333 | Gauge Instrument for use in a motor vehicle | Jun. 11, 2002 |
| D440925 | Instrument display for a vehicle | Apr. 24, 2001 |
| D423434 | Automobile instrument panel | Apr. 25, 2000 |
| 5,920,256 | Gauge with Mechanical Indicator and Reconfigurable Gauge Display | Jul. 6, 1999 |
| 5,272,463 | Display device for vehicles | Dec. 21, 1993 |
| D276039 | Automobile instrument panel | Oct. 23, 1984 |

### FIELD OF THE INVENTION

This invention relates to vehicle information displays (also known as instruments, dashboards, panels, clusters), and particularly, to an information display for vehicle occupants where traditional dashboard and/or instrument panel exists.

### BACKGROUND OF THE INVENTION

The present invention relates to an instrument panel used for moving vehicles, including automobiles, aircraft, helicopters, motorcycles, watercraft (such as boats, yachts, jet skis, submersible crafts). This invention applies to any vehicle that requires manned or unmanned operator that has information display and control mechanisms.

The vehicle instrument panel has typically provided information concerning the operation of the vehicle, time, outside temperature, and the like. Instruments concerning operation of the vehicle have traditionally been located in the panel in front of the vehicle operator within the dashboard. Ancillary electronic displays, such as clock, climate control, radio, GPS mapping, and the like, were also located in the panel often in the middle between the driver and the passenger so as to be viewed and regulated by both, the driver and passenger. Various knobs, switches and buttons were scattered throughout the vehicle.

These instruments are static and in fixed position. These instruments often include a speedometer for indicating the speed of the vehicle, a tachometer for showing the speed of the engine, and various other gauges for showing engine temperature and fluid levels, for example. Similar instrumentation is present on aircraft, boats, motorcycles and other vehicles. For example, the speedometer and the climate control are in the same position; same size and do not move. The only thing that changes is the information display produced by the gauges, or how a switch was adjusted, in the on or off position, until the next adjustment by the operator or the passenger.

These instruments often include analogue gauges wherein a needle or pointer is mounted on the rotary output shaft of a gauge motor and assumes different positions based on the control signal received by the gauge. The needle is positioned near a display bearing markings relevant to the condition being measured, and the needle points to various marks as it turns. For example, if the gauge is part of a speedometer, the markings on the display will indicate various rates of speed in miles or kilometers per hour. Sensors measure the rate of speed of the vehicle and send signals proportional to that speed to the gauge causing the needle to point to the appropriate marking on the display. Toffolo et al (U.S. Pat. No. 5,920,256) presented a reconfigurable gauge display, but that was for mechanical gauges which could not be electronically moved on-demand from one location to another within the vehicle in real-time. There have been many utility and design patents issued for instrument panels (D571271, D562748, D557646, D546744, D543139, D531557, D529847, D529423, D512357, D512006, D4999998, D493756, D491504, D489660, D483309, D467845, D440925, D423434, D276039, U.S. Pat. Nos. 6,404,333, 5,272,463), but they all have fixed analog or electronic gauges that cannot be moved nor are bendable along the contour of the vehicle in a graphical format. A few patents (D494908, D493757, D492632, D469391) discussed configuration of the dashboard, but those do not have electronic information displays contouring the vehicle, nor do they have adjustable gauges or information panels.

Instrumentation must be visible to a person operating a vehicle, and many of the instruments must be read while the vehicle is in motion. A driver will generally focus on the road in front of him when driving, and thus the most convenient location for placing instrumentation has been directly below the driver's gaze, on the dashboard of the vehicle. Furthermore, the most important instruments must be large enough for the driver to read and interpret quickly. A vehicle traveling at 60 miles per hour moves 88 feet per second. Thus a driver takes his eyes off the road for 88 feet every time he looks at an instrument for one second. If the instrumentation is small or cannot be read quickly, or if driver reads several gauges in same glance, an even greater time will elapse. In addition, a person's eyes take a certain amount of time to adjust when shifting focus from a distant point to a proximate point, and a similar time elapses when attention is returned to the distant point. Changes in lighting between the interior and exterior of the vehicle can also make it difficult to switch focus between the road and the dashboard. The go constant shifting of attention from the road to the instruments and the re focusing of eyes involved in this process can be distracting and had the potential to contribute to the occurrence of accidents.

It is argued that same instrument cluster layout should not be same for everyone or every situation. If a driver is on a freeway, a speedometer may be the most important gauge. If the vehicle is low on gas with few gas stations in the area, the gas gauge and gps showing nearest gas station may be the most important. If a truck, carrying heavy load is climbing up a mountain, a tachometer, temperature or oil gauge may be the most important. If a taxi driver is trying to find the next location, navigation system may be the most important. An elderly individual may need a larger or better lighted gauge than a younger counterpart. Yet, all the gauges and displays have traditionally remained in their same static position as preset by the factory.

Recently, some manufacturers have implemented a heads-up display (HUD) which projects information onto the interior of the windshield directly in front of the vehicle operator. However, this technology still presents the same gauges, in fixed position, and is often difficult to read in daylight hours.

No one has previously provided Bendable On-Demand Displays (BODD) for vehicles. These displays bend with the contour of the vehicle and wrap around the occupants. The display provides on-demand information based on user preferences, where gauges are not static but rather may change shape, form and information produced.

### SUMMARY OF THE INVENTION

The object of the present invention provides information to an operator and occupants of the motor vehicle through a bendable on-demand display. The display system is designed to serve as a centralized control point for most vehicle comfort, entertainment, safety and information display functions. The use of microprocessor based display controller of this type also facilitates advanced functions such as sophisticated trip computer functions, online Internet connectivity, Bluetooth connectivity and synchronization with personal digital assistants, mobile phone, voice response, GPS functionality and mapping including traffic, weather, location-based networking and integration with home automation and external computers, to name a few. Parts of the display are touch sensitive which allow user to adjust settings such as radio, climate control system, GPS unit. The system has touch-screen capability. The display can wrap around whole or part of the vehicle, with pre-determined break points. The display can also, inform the occupants about any road hazards, warnings or present information in a human voice.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain in the principles of the invention.

FIG. 1 is a top view, depiction A with a perspective view showing an instrument panel unit including an instrument panel and a vehicle body frame section according to an embodiment of the present invention;

FIG. 2 is a top view, depiction B with a perspective view showing an instrument panel unit including an instrument panel and a vehicle body frame section according to an embodiment of the present invention. The contour of BODD is that it can bend at sharp angles, such as 90 degrees, all while displaying the information to the occupants;

FIG. 3 is the perspective view of the instrument front panel, what front occupants would see directly in front of them. The steering wheel is on the left (another option for it to be on the right);

FIG. 4 is a front and side lateral depiction;

FIG. 5 is a schematic side slice view of the instrument panel;

FIG. 6 is a schematic showing a sample curvature of the display panel;

FIG. 7 is a front and side lateral depiction with a sample representation of instrument panel information displays;

FIG. 8 is a front and side lateral depiction with a sample representation of instrument panel information displays;

FIG. 9 depicts Bendable On-Demand Display Command Center;

### DETAILED DESCRIPTION OF THE INVENTION

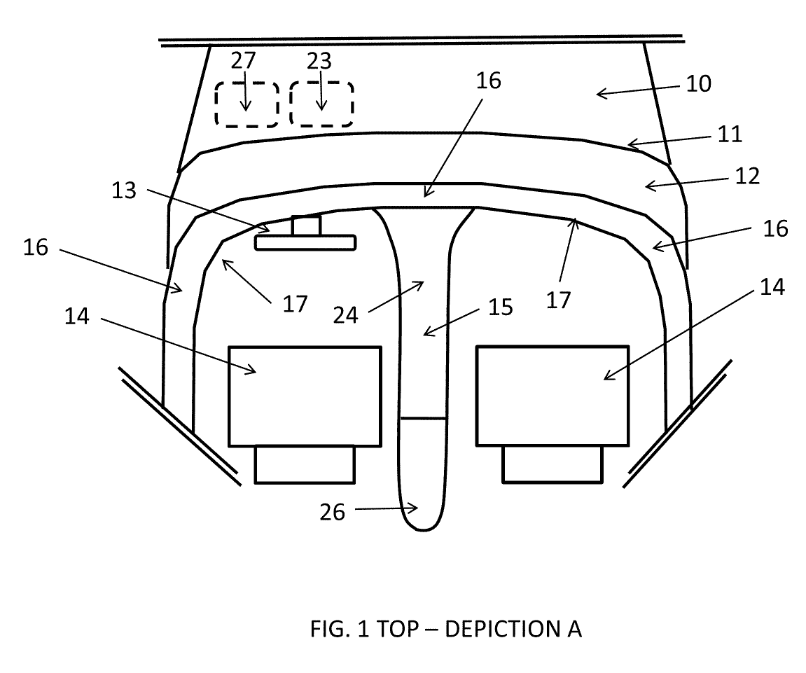

For the purposes of the following description, the terms “upper,” “lower,” “right,” “left,” “vertical,” “horizontal,” and derivatives or equivalents thereof shall relate to the invention as oriented in FIG. 1. It is understood that the invention may assume various alternative orientations, except where expressly specified to the contrary. It is also understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not considered limiting unless the claims expressly state otherwise. Accordingly, various modifications may be made without departing from the spirit of scope of the general inventive concept as defined by the appended claims and their equivalents.

An embodiment of the present invention will be described below with reference to the accompanying drawings.

Referring now in detail to the drawings and in particular to FIG. 1 thereof, the numeral 10 denotes generally a motor vehicle. The vehicle includes a windshield 11, top of dashboard 12, steering wheel 13, seats 14, dividing console between occupants 15, and the Bendable On-Demand Display (BODD) 16 of this invention. The BODD 16 is arranged in front of the driver and/or passenger 14. Under the hood, or can be placed anywhere within the body of the vehicle are BODD Command Center 27 and optional backup battery 23. BODD Command Center 27 controls the information it receives from various sensors, how it displays that information and interacts with the user. Backup battery would ensure power is always available for BODD in case the main vehicle battery becomes un-operational. The area where a traditional console-based gear shifter is traditionally located 24 could be eliminated and series of touch-screen buttons could be in its place. The front end of mid console 15 could display information, whereas the back part 26 of the console could be used for storage.

FIG. 1 shows concave 17 shape of the BODD. The formation of the display makes it possible for continuous, uninterrupted information display wherever BODD is present.

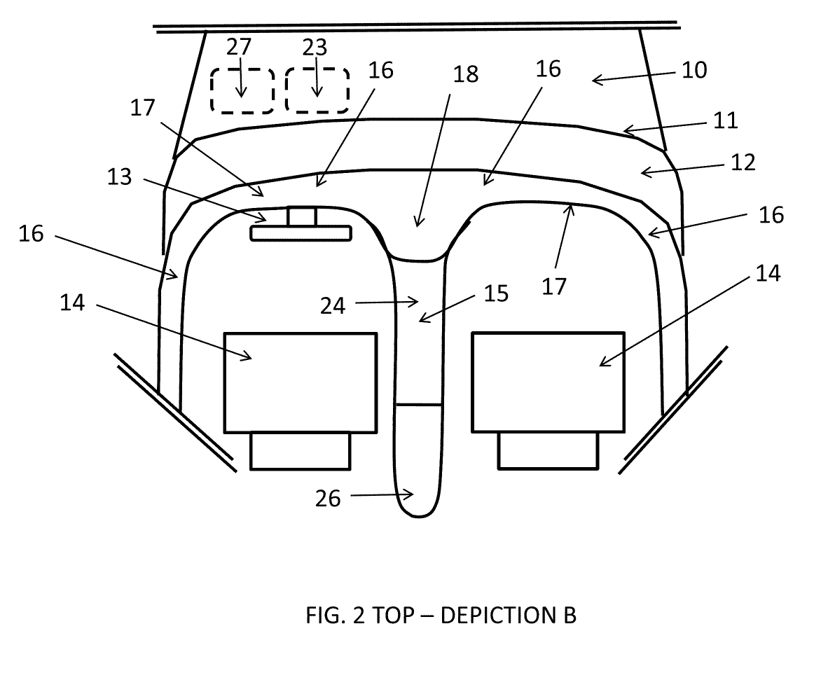

With reference to FIG. 2 of the drawings, which is another depiction of FIG. 1, it may be appreciated that BODD may comprise of concave 17 shape around the vehicle occupants, but convex 18 shape as it flows seamlessly between the occupants. The BODD will wrap around the occupant in such a fashion as to present a seamless integration even if there is a break in the dash at such a point where a door may force a physical break. Once the door is closed there would be a minimal gap between the two portions of display. Bendable display can be incorporated into the door.

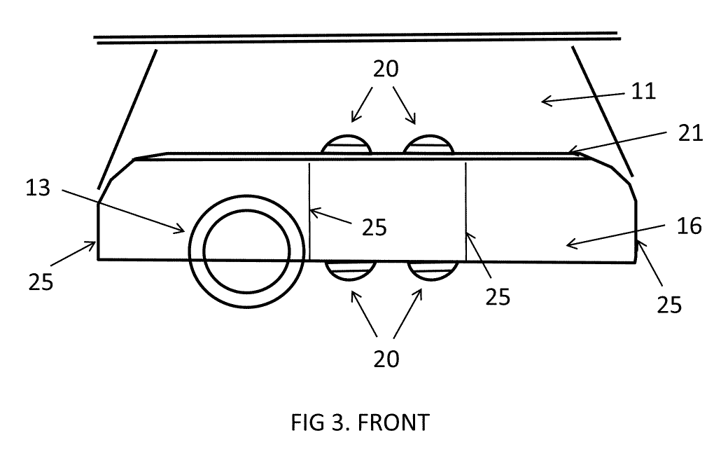

FIG. 3 shows what the BODD would look like if the vehicle occupant was to look directly forward, or ahead, without looking at sides. The climate control vents 20 can protrude above and/or below the BODD. Alternatively they can be embedded within BODD though pre-fabricated openings at strategic locations throughout the vehicle. There may be a strategically placed slight overhang 21 at the top of BODD to help block the sunrays and allow for better visibility of the digital displays.

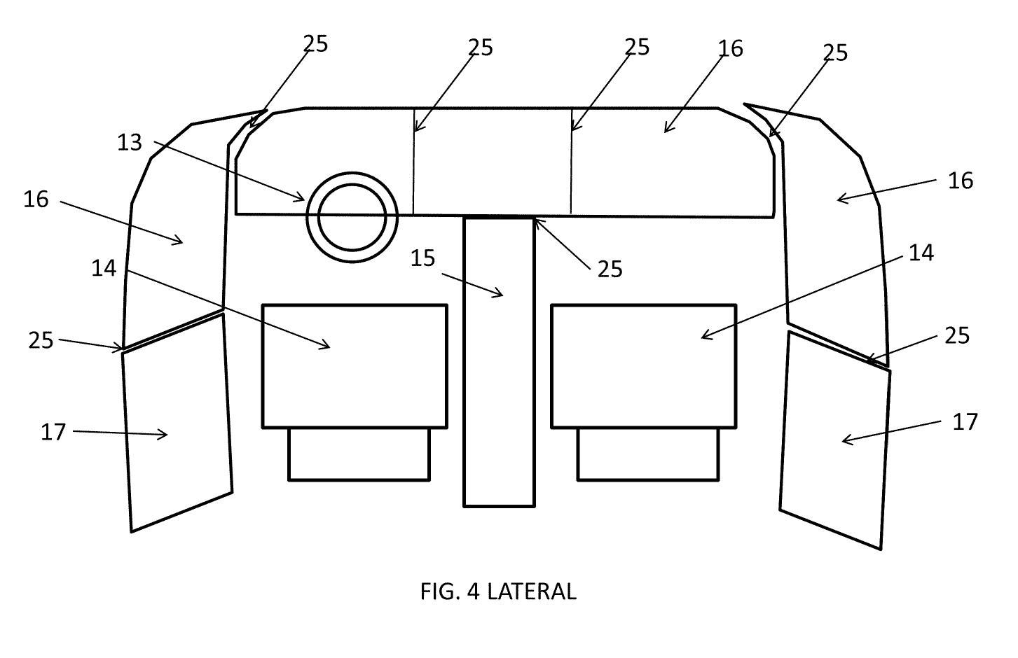

FIG. 4 represents lateral view of the inside of a vehicle depicting surface areas of the BODD. What important to realize here is that BODD curves from the one side of the car, possibly integrated with the door, around the driver, across the width of the vehicle, finally wrapping around the other side to the right and possibly integrating with the door. BODD could be attached and integrated into the vehicle with several portions 25 to make installation easier. In addition in case part of the screen goes bad or vehicle is damaged in an accident, only those portions damaged would be replaced as opposed to the entire system.

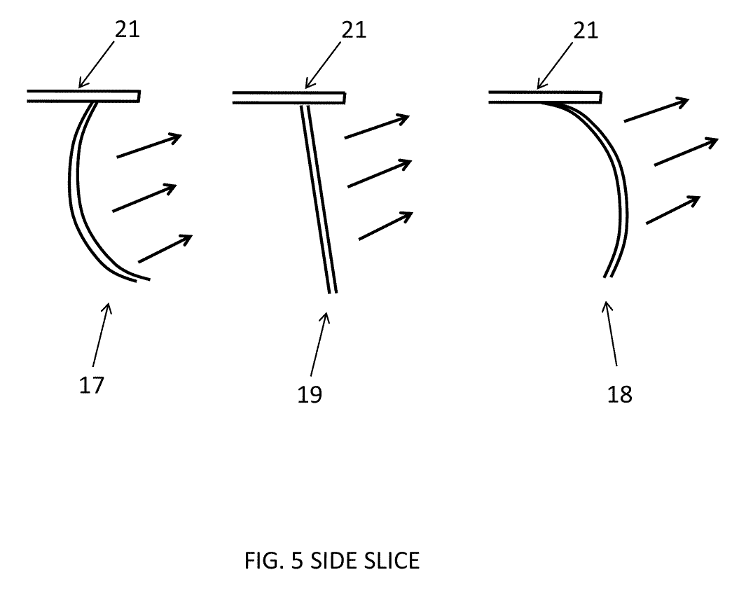

FIG. 5 is a schematic side slice view of the instrument panel. It shows that BODD can take many forms not only in horizontal plane, but vertical plane as well. It can be concave 17, straight 19, or convex 18 shape. The arrows indicate the viewing angle. It is presumed that BODD would be slightly angled for better eye visibility of the information display. Actual display would be synthesized and manipulated as thin flexible, stretchable films on top or embedded in the curvature of the dashboard. The dashboard can be convex, concave or straight in nature. BODD can also form “S” shape where concave, straight and convex angles alternate.

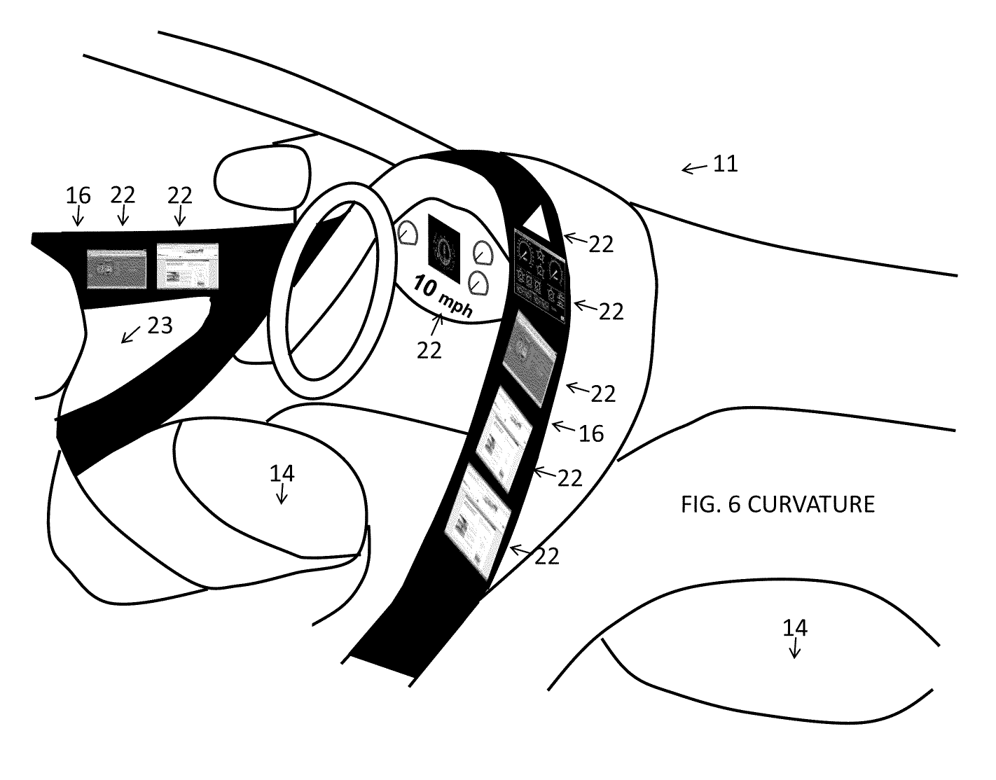

FIG. 6 is a drawing showing a sample vehicle with BODD wrapping around the driver only. Various gauges 22 can be displayed within BODD 16. These gauges can be resized, moved, and are touch-screen sensitive. As depicted, BODD can flow around into the door 23 and wrap the occupants within the vehicle.

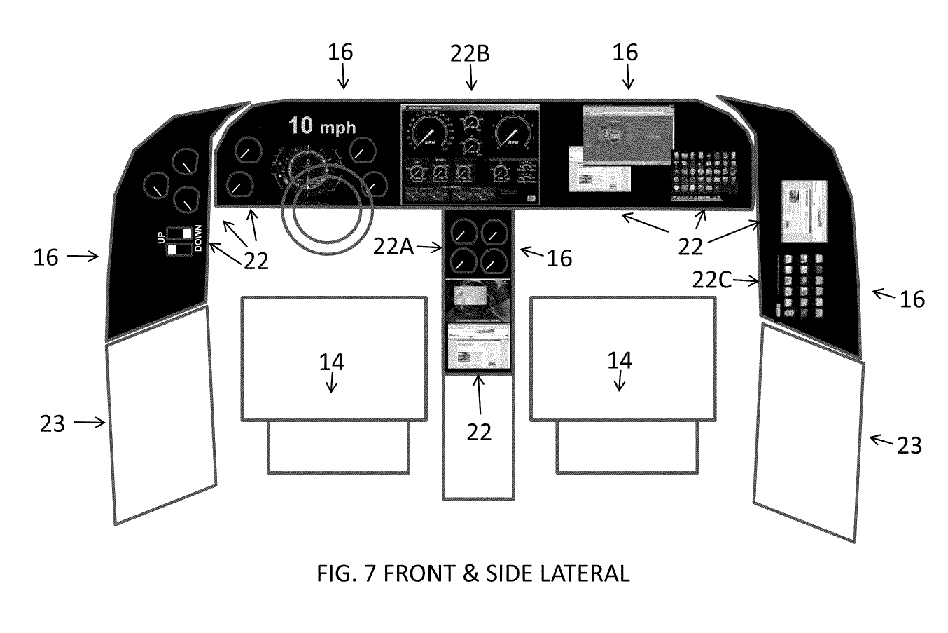

FIG. 7 is a sample lateral depiction of how information could be displayed within the vehicle. The invention could replace hard switches such as door handles, window buttons, side mirror buttons or ignition key. Controls levers, knobs, switches, handles, buttons, gauges would mostly be replaced with touch screen controls and integrated seamlessly.

Instead, the vehicle occupants would see an electronic display consisting of touch sensitive icons displaying various levers or buttons. If the vehicle is traveling at high speed, for example, the electronic depiction of a door handle may be grayed out. Or if the vehicle senses an obstruction in an open window, an “up” button for the window may be grayed out or a warning light and/or sound may occur. Once the occupant has entered the vehicle, system authenticating identity of the driver can be grayed out or made invisible after authentication.

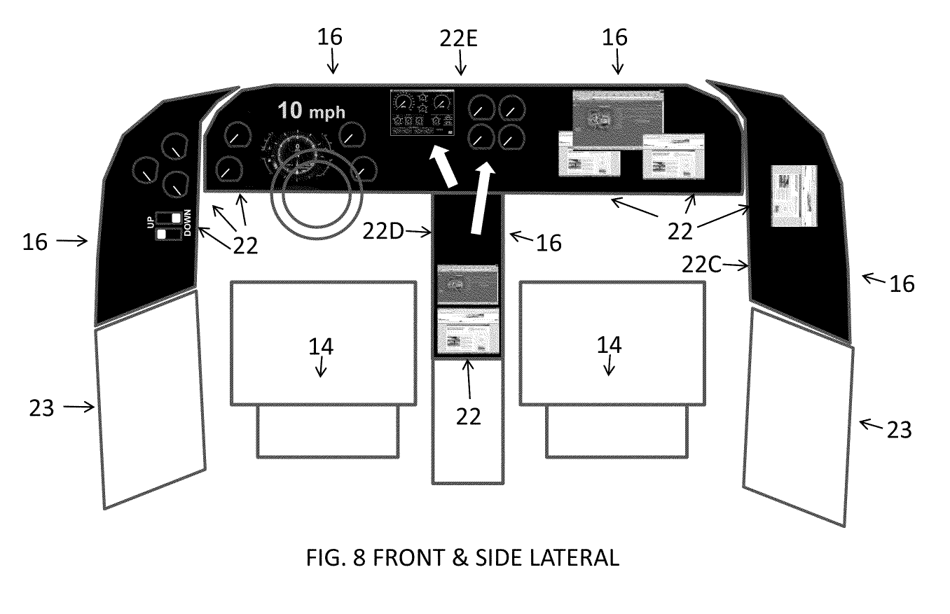

All of the displays would be electronically displayed to the vehicle occupants. This drawing shows BODD 16 stopping before doors 23. Gauges 22 could be positioned in almost endless configuration within BODD 16. It is noted a sample depiction of gauges 22A, 22B and 22C in FIG. 7 and how they could be changed in FIG. 8.

FIG. 8 is the same drawing as FIG. 7 but it shows how information, gauges can be moved, resized, deleted and added on the vehicle. As seen, gauge 22A was moved to replace where gauge cluster 22B used to be. 22E now represents part of 22D, plus additional gauges. 22C was present in FIG. 7 and deleted in FIG. 8. These are examples of various configurations and how BODD could be reconfigured dynamically.

For example, user can minimize tachometer and place it to left of speedometer, which user can make larger. The next day the driver may want to replace tachometer with a temperature gauge and instead of dial-type, make it bar-type and place it to the right of speedometer. User could set threshold that if vehicle goes over 75 mph to display and voice prompt a warning to the driver. A driver could set her house thermostat to lower setting through wireless integration with home automation system prior to arriving home. Telematic video conferencing, weather & traffic reports, GPS vehicle tracking and remote assistance would all be possible through integration with the unit. For entertainment, the passengers could play videos, movies, games, online games, listen to music or mp3 players, and talk on their phone through wireless integration such as Bluetooth. Parental controls could be enforced by limiting the vehicle speed, time of day vehicle can be controlled and areas the vehicle may not travel beyond or to allow through GPS and navigation controls. If the vehicle is stolen, the owner could remotely disable the vehicle and locate it through location-based services. The system would memorize preferences of several drivers. Vehicle collision avoidance system can deploy safety devices milliseconds before unavoidable collision. The system could warn the driver of road hazards ahead or display night vision through BODD.

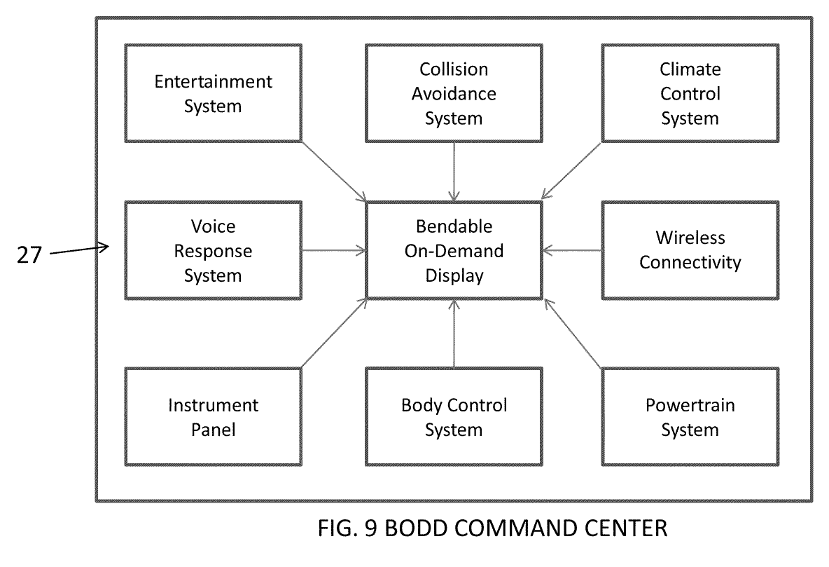

FIG. 9 is the BODD Command Center 27 that collects information from various sources within and outside the vehicle, processes that information and presents them to the occupants. Such information may include:
A) Entertainment System comprising of games, trivia, video conferencing, phone, PDA connectivity, home or office automation;
B) Collision Avoidance System consisting of information about the location of the vehicle through GPS coordinates. It uses mathematical models to predict where the vehicle is going based on speed, road conditions, and powertrain (steering wheel, acceleration, brakes). It collects similar information from other vehicles in close proximity. The system analyzes the information and predicts if there is a probably collision with another vehicle. It can also sense if there is an object around the vehicle and warn the driver if the object is too close.
C) Climate Control System allows for temperature and ventilation adjustments;
D) Voice Response System enables occupants of the vehicle to use natural speech commands in several languages to interact with BODD;
E) Wireless Connectivity provides occupants ability to connect to outside of the vehicle through wireless internet, GPS, satellite links. This enables occupants to use cell phone through the vehicle, use navigation system based on GPS coordinates, communicate with home or office automation and collect and process data points from other vehicles surrounding their own vehicle;
F) Instrument Panel collects information from various points within the vehicle dealing with gauges and instruments such as speedometer, odometer, tachometer, fuel, temperature, tire pressure, and so forth;
G) Body Control System where vehicle diagnostic codes would feed into control unit which would disseminate and make info available to the operator;
H) Powertrain System which would collect essential data elements from the powertrain of the vehicle, such as engine and transmission information.

The above description is considered that of the preferred embodiments only. Modification of the invention will occur to those skilled in the art and to those who make and use the invention. Therefore, it is understood that the embodiments shown in the drawings and described above are merely for illustrative purposes and are not intended to limit the scope of the invention, which is defined by the following claims. Graphical user interface (GUI) creativity would dictate how the panel is laid out with what components available to the occupants.

The embodiments of the invention in which an exclusive property or privilege is claimed are defined as follows:

1. A wrap-around, Bendable On-Demand Display for use in vehicles comprising:
a. an information instrument that has characteristics of bendable electronics extending in a cross direction of the vehicle, partially wrapping and bending to the contour of the vehicle interior around vehicle occupants to various degrees (the driver, passenger, driver and passenger, passengers);
b. encompassing the occupants in whole or part, with pre-determined break points;
c. an information instrument panel body made of electronic display;
d. instrument panel that shows on-demand real-time displays, which comprise of any of the following:
i. static displays in fixed position;
ii. moving displays which adjust according to vehicle conditions and options of the vehicle occupants;
iii. placed based on factory or user preferences;
iv. adjustable in real-time in placement, size, dimension, color and information displayed;

2. A Bendable On-Demand Display as claimed in claim 1, wherein said invention is to be used in moving vehicles including automobiles, aircraft, helicopters, motorcycles, watercraft (boats, yachts, jet skis, submersibles), military equipment (such as tanks, aircraft, submarines, ships). This invention applies to any vehicle;

3. A Bendable On-Demand Display as claimed in claim 2, wherein said invention provides means to electronically display graphics, text, video or moving graphics to vehicle occupants;

4. A Bendable On-Demand Display as claimed in claim 3, wherein said invention to be composed of electronic imaging display such as LCD, Plasma, TFT, graphene, silicon, nanomembrane and similar electronic display mechanisms;

5. A Bendable On-Demand Display as claimed in claim 4, wherein said invention is bendable without losing its function. This is possible by transfer and bonding of completed circuits to a flexible substrate and/or fabrication of the electronic or molecular circuits directly on the flexible substrate;

6. A Bendable On-Demand Display as claimed in claim 5, wherein said invention includes touch-screen controls;

7. A Bendable On-Demand Display as claimed in claim 6, wherein said invention has the ability for occupants to move and select the gauges, on-screen information and menus through touch-screen drag and drop controls with a finger and/or voice commands;

8. A Bendable On-Demand Display as claimed in claim 7, wherein said invention has the information arranged through menus, folders, gauges, and controls;

9. A Bendable On-Demand Display as claimed in claim 8, wherein said invention connects to a master microprocessor incorporated in said Display Unit for issuing control signals and responding to control signals representative of major system functions;

10. A Bendable On-Demand Display as claimed in claim 9, wherein said invention having storage means to store vehicle information, external information and occupant preferences;

11. A Bendable On-Demand Display as claimed in claim 10, wherein said invention contains transmitting and wireless capability with external devices such as personal digital assistants and wireless connectivity for network and phone connections;

12. A Bendable On-Demand Display as claimed in claim 11, wherein said invention has an ability for instrument display to announce in human voice the reading of gauges and/or emit warnings and having voice recognition capability based on user and/or factory predefined thresholds and control limits;

13. A Bendable On-Demand Display as claimed in claim 12, wherein said invention has an ability to emit warnings if collision avoidance system is triggered;

14. A Bendable On-Demand Display as claimed in claim 13, wherein said invention has an ability to adjust light, color of the gauges and information display;

15. A Bendable On-Demand Display as claimed in claim 14, wherein said invention has an ability for the vehicle occupants to select personal preferences of look and feel of the information panel;

16. A Bendable On-Demand Display as claimed in claim 15, wherein said invention integrates with vehicle command center, database, and vehicle diagnostics and measuring devices.

17. A Bendable On-Demand Display as claimed in claim 16, wherein said invention uses a GPS system and functions processed within the vehicle to predict and avoid collisions with other vehicles and objects.
